(19) United States
(12) Patent Application Publication
(10) Pub. No.: US 2012/0168098 A1
(43) Pub. Date: Jul. 5, 2012

(54) Garage Door

(76) Inventor: Greg James, Lake Munmorah (AU)

(21) Appl. No.: 13/382,579

(22) PCT Filed: Jul. 9, 2010
(86) PCT No.: PCT/AU10/00880

§ 371 Date: Mar. 19, 2012

(30) Foreign Application Priority Data
Jul. 9, 2009 (AU) 2009903211

(51) Int. Cl. E06B 5/00; E05D 15/24; E05F 15/08

(52) U.S. Cl. 160/189; 16/94 R; 16/91

(57) ABSTRACT

An overhead sectional door includes a sectional door curtain (12) made up of a plurality of sectional panels (14) pivotably attached together, and guide wheels (16) which engage and travel within a pair of tracks (18) and (20) at each side of the door (12). The tracks (18,20) are spaced substantially outwardly from the side extremity of the door panels (14), and a torsion spring assembly (60) is mounted so as to be raised and lowered with operation of the door curtain and extends beyond the side extremities of the door panels.

### BACKGROUND OF THE INVENTION

1. Field of the Invention

The present invention relates generally to overhead ‘garage’ doors, of the type used to close large openings in residential and commercial buildings. More particularly, the present invention relates to overhead doors of the sectional type, and to a counterbalance arrangement for such doors.

2. Description of Related Art

Sectional garage doors are well known in the art. Although the design of sectional garage doors can significantly differ, certain components are common to such door systems. Thus a typical sectional garage door has a door curtain made of a plurality—usually four or more—panel sections hinged together at their longitudinal edges about horizontal hinge axes.

A pair of generally inverted L-shaped guide tracks is mounted to the building, one at each side of the door opening, with the vertical leg of the L being at the side of the door opening and the horizontal leg being above the level of the opening and extending back into the building space. The junction of the horizontal and vertical legs of the track is radiussed.

The door includes a plurality of rollers mounted on the opposite sides of the door sections, which follow the guide tracks to guide movement of the door curtain between a closed (lowered) position in which the door is vertical and closes off the door opening and an open (raised) position where the door is stored overhead in a horizontal orientation.

Since a sectional door is relatively large and heavy, it is commonplace to provide a counter-balancing spring system which loads up one or more torsion or extension

Since a sectional door is relatively large and heavy, it is commonplace to provide a counter-balancing spring system which loads up one or more torsion or extension springs as the door is lowered, so that the spring tension assists raising of the door. Such systems are commonly used even where the door is power operated.

A typical counter-balancing system includes one or more torsion springs on a horizontal torsion shaft which is secured to the building structure above the door opening. The shaft has a cable drum with a cable connected to the bottom section of the door. As the door is lowered, the withdrawal of the cable causes the shaft to turn, winding up the torsion spring. The number and size of the springs is selected so that spring tension is selected to counterbalance part of the weight of the door, so that the door is easier to raise.

WO 2007/051237 discloses a sectional garage door arrangement where the torsion spring is positioned on the lowest panel of the door, providing improved ease of installation, aesthetics and headroom compared to the conventional overhead spring arrangement.

The door of WO 2007/051237 provides a workable garage door arrangement, but there are a number of aspects of that arrangement which could be further improved upon from a manufacturing and/or ease of use or installation viewpoint.

### SUMMARY OF THE INVENTION

In a first aspect, the present invention provides an overhead sectional door apparatus operative to open and close a door opening, including:
a door curtain having a plurality of connected panels each having opposite side extremities;
guide track means for guiding movement of the door curtain between a closed, lowered position and an open, overhead position; and
a counterbalancing mechanism for applying a counterbalancing force acting against the weight of the door curtain, including:
   a torsion spring mechanism mounted to the door curtain so as to be raised or lowered with operation of the door; and
   a loading mechanism for loading the spring as the curtain is lowered, so as to create a counterbalancing force acting against the weight of the door curtain,
      wherein the loading mechanism includes a torsion shaft portion and associated winding mechanism which are positioned outwards beyond at least one of the side extremities of a panel to which the spring mechanism is mounted.

Preferably, the winding mechanism comprises a cable reel.

Preferably also, the guide track is spaced outwardly from the side extremities of the panels, and said torsion shaft portion and winding mechanism are located between the track and the panel side extremity.

Preferably, the door apparatus further comprises a drive motor for raising and lowering the door curtain, the motor being substantially centrally mounted on the door panel and being connected to a respective loading mechanism at each side thereof.

In one preferred form, the door panel includes a side reinforcing member, and the torsion shaft extends through the side reinforcing member.

A further aspect of the invention relates to a guide track and axle arrangement for an overhead sectional door apparatus, including:
a door curtain having a plurality of connected panels each having opposite side extremities;
guide track means for guiding movement of the door curtain between a closed, lowered position and an open, overhead position; and
axles and guide members associated with the panels for guiding movement of the panels relative to the guide track;
   wherein the axles and/or guide members are adapted for disengagement of the curtain from the track so that individual panels of the door may be replaced without disengaging other panels from the guide tracks.

In one form, the axle is formed in a first portion attached to the door panel and a second portion carrying a guide wheel, the two portions being separable while in situ. Preferably, the two portions are removably screwed together, and have formations for engagement of tools.

Further aspects of the invention will become apparent from the illustrated embodiments and detailed description.

### BRIEF DESCRIPTION OF THE DRAWINGS

Further preferred embodiments of the invention will now be described with reference to the accompanying drawings, in which:

FIG. 1 is a front view of an example garage door installation according to one embodiment of the invention;

FIG. 2 is a detail of a portion of a generally similar garage door installation to that of FIG. 1;

FIG. 3 shows further detail of mounting of the torsion spring to a portion of a door panel;

FIG. 4 shows an axle and guide wheel arrangement according to an example embodiment of the invention;

FIG. 5 is a perspective view of the axle and wheel arrangement of FIG. 4 attached to a door panel;

FIG. 6 is a front view of a motor disengagement cord arrangement mounted to the door curtain, in a further example embodiment of the invention; and

FIG. 7 is a front view of the centre lower section of a garage door, illustrating an example of a motor disengagement arrangement.

### DETAILED DESCRIPTION OF PREFERRED EMBODIMENTS

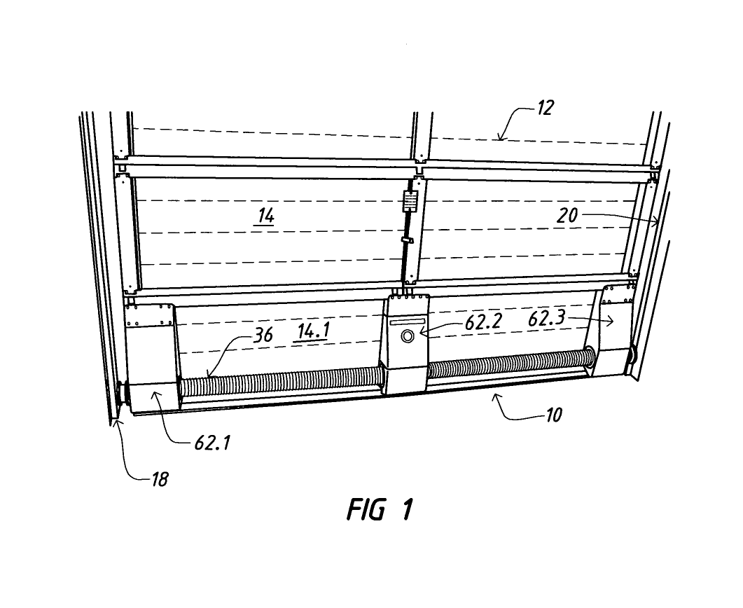

With reference to FIGS. 1 to 3, the illustrated garage door installation 10 is of generally similar configuration and operation to that described in WO 2007/051237, including a sectional door curtain 12 made up of a plurality of sectional panels 14 pivotably attached together, and guide wheels 16 which engage and travel within a pair of tracks 18 and 20 at each side of the door 12.

A torsion spring counterbalance assembly generally referred to as 60 is mounted to the bottom door panel 14.1, again in a generally similar manner to that in WO 2007/051237 with a torsion shaft 31 rotating with the cable drum 32 to load and unload the torsion on the torsion spring 34 as the door is lowered and raised.

The torsion spring assembly itself is of construction and operation similar to those used in the prior art, and the general construction and operation of such torsion spring arrangements will be well understood to those skilled in the relevant art.

The torsion spring assembly is secured to the panel via modified bottom stiles or muntins (vertical reinforcing members) 62.1, 62.2, 62.3 of the panel frame. To this end, the stiles 62 are tapered outwardly towards their bottom to accommodate the counter-balancing assembly 60. The side stiles 62.1 and 62.3 thus perform the function of end bracket plates of a conventional overhead counter-balancing assembly, with the similarly shaped centre stile 62.2 capable of performing the function of a centre plate, and also serving to cover a remotely-controlled drive motor (not shown) for raising and lowering the door.

The contents of WO 2007/051237 are incorporated herein by reference.

Whilst the present arrangement has similarities in overall arrangement and operation to WO 2007/051237, it differs in a number of respects.

The tracks 18,20 are spaced substantially outwardly from the side extremity of the door panels 14, e.g. with at least about 10 cm gap, preferably at least about 15-20 cm, and mounted to the building adjacent the door opening by means of at least one L-shaped member, for example a metal angle section 22 as illustrated or discrete L-shaped brackets. These L-shaped members are oriented oppositely to the brackets of WO 2007/051237, with the portion of the angle which abuts the building extending back under the track towards the door opening, thus being positioned behind the gap between the track and the side edge of the door curtain. This arrangement helps to reduce the side clearance needed at the sides of the door, and also allows inclusion of a flexible ember seal—e.g. a brush-type seal—attached to the L-shaped member(s) and forming an ember and/or dust seal against the outer surface of the door panels.

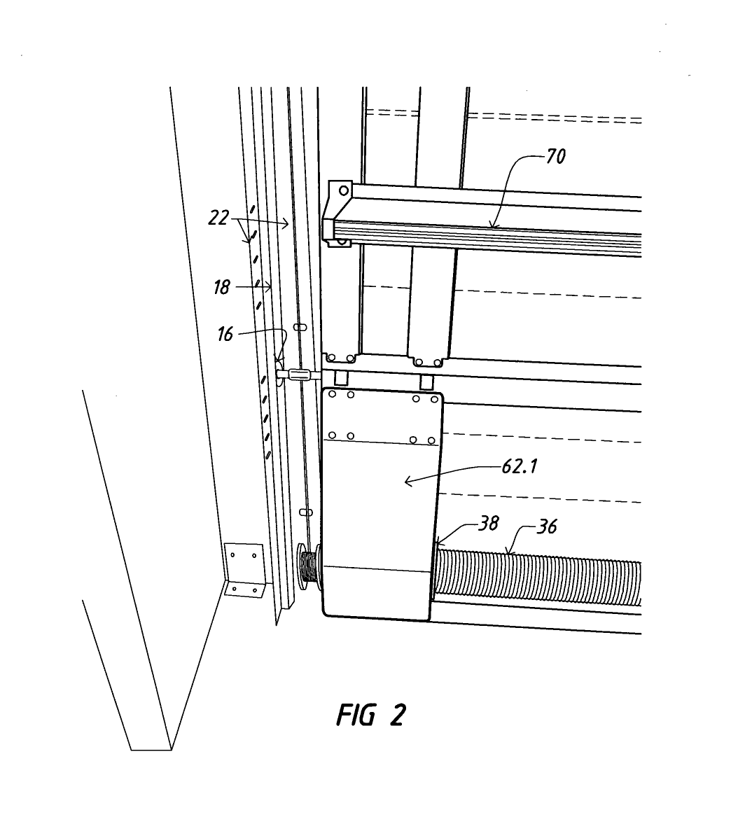

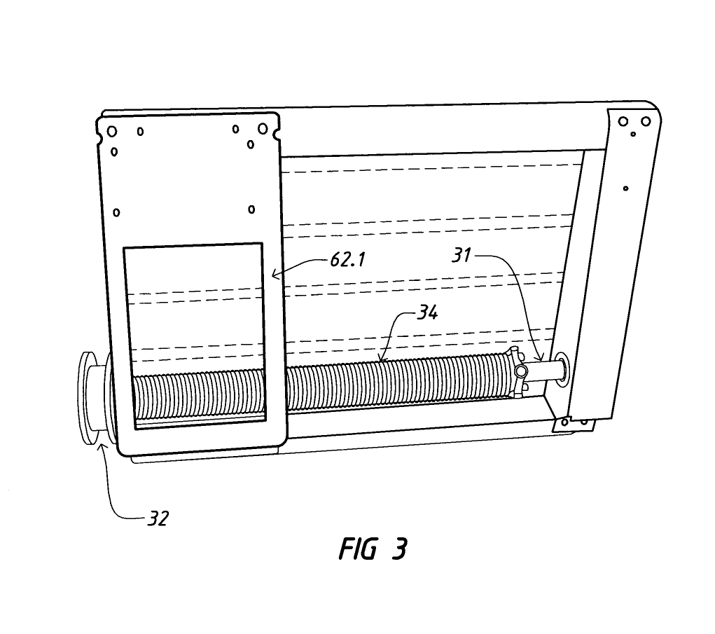

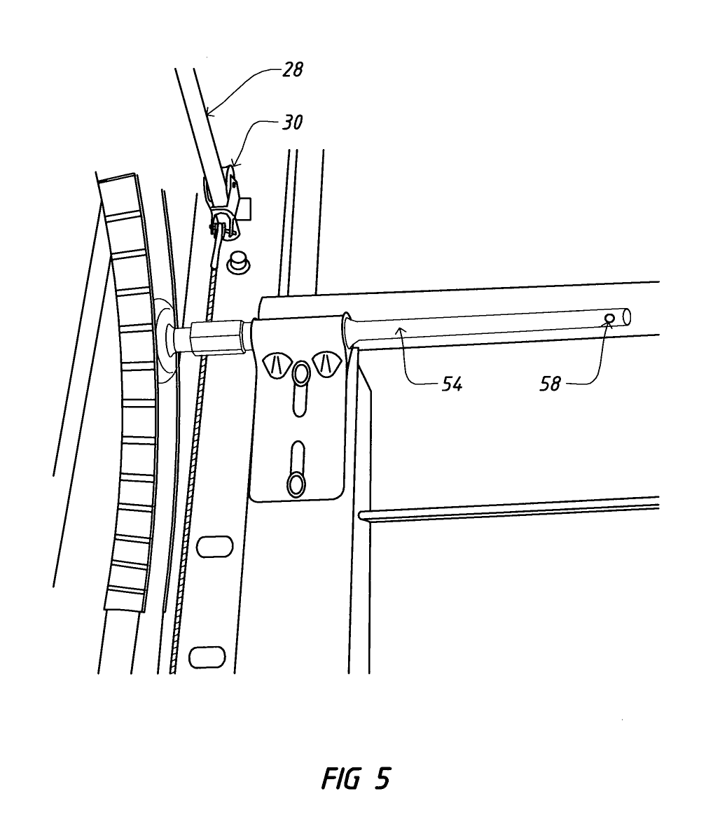

As shown in greater detail in FIGS. 2 and 3, the torsion spring and torsion shaft arrangement extends through the side stile of the door panel, out to substantially the edge of the door panel, as best seen at the cutaway section of the stile in FIG. 3. The cable reel is located in the gap between the side of the door and the track and the cable runs up along this gap, passing behind the extended length axles of the panel guide assemblies up to fixing bracket 28 and sleeve 30 arrangement (FIG. 5) generally as described in WO 2007/051237. By adopting this positioning of the cable reel, a greater length of torsion spring may be fitted to a given width of door compared to WO 2007/051237, allowing greater flexibility in achieving a suitable balance force for any given width and height of sectional garage door and thus extending the range of door dimensions for which the counterbalance mechanism is suitable.

Also, the side overlap of the door curtain compared to the door opening is reduced compared to WO 2007/051237. In addition, the position of the fixing bracket 28 for attachment of the cable is moved across towards the guide track 18, 20 compared to that in WO 2007/051237, which allows for attachment of the bracket to the guide track rather than the cantilevered arrangement of WO 2007/051237.

A further improvement over WO 2007/051237 is in the safety cover for the torsion springs. More specifically, the presently illustrated embodiment includes a retractable sleeve 36 surrounding the torsion springs, which engages with apertures 38 in the side 62.1 and centre 62.3 stiles of the door panel to be removably retained in place about the torsion spring. The tube may be formed of any suitable material and with any suitable retraction mechanism but, in one example form, the sleeve is formed of a concertina tube—such as of plastic material or wire-reinforced plastics. The tube is retractable in its longitudinal direction so that access may be gained to the torsion spring and shaft arrangement, for example for connection and disconnection to the drive motor as will be described below.

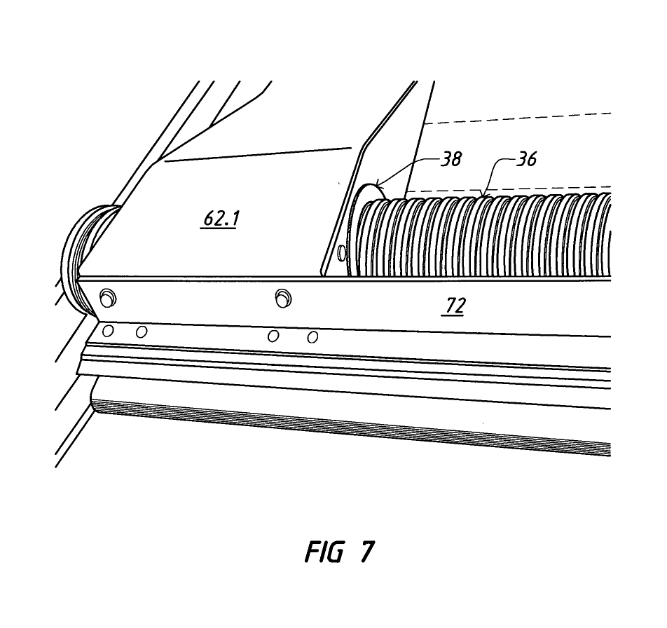

The torsion shafts 31 are preferably removably connected to the drive shafts (not shown) from the motor by means of a demountable drive coupling, for example of a type known per se. Suitable mechanisms may include a collar arrangement 40 as shown in FIG. 7, or the use of matching formations such as keying or castellation on the respective ends of the torsion and motor drive shafts, and a locking mechanism such as a locking pin or screw. A threaded or bayonet connection may also be used. The demountable drive coupling gives the door installer the option, if desired, of first installing the door panel and motor assembly in position on the guide tracks then attaching the torsion spring assemblies, to reduce the weight of the bottom door panel on initial installation. Also, once installed, the demountable coupling can be accessed and decoupled from the motor drive for repair or replacement of the motor or the torsion spring assembly.

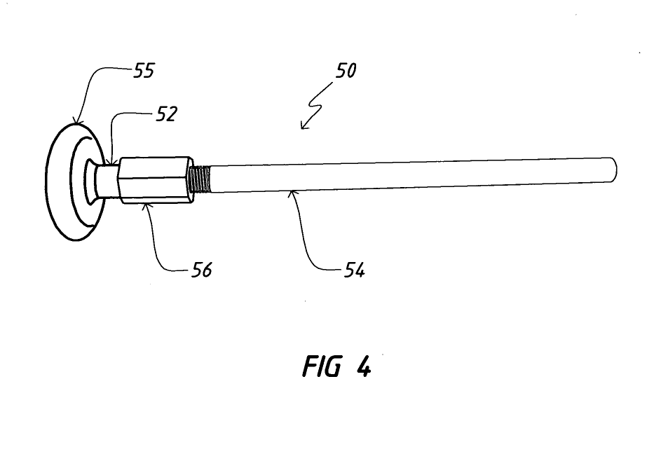

FIGS. 4 and 5 show more detail of the axle and guide wheel arrangement for supporting the door curtain on tracks.

FIG. 4 shows the assembly removed from the door, and FIG. 5 shows the assembly attached to the upper door panel in use. Whilst in FIG. 5 the axle arrangement is fully exposed apart from the portion received in the side stile of the panel, on the other panels of the door the tail of the axle will typically be received within the folded-over top lip of the door panels (see for example FIG. 2) and not normally be visible.

As seen in FIGS. 4 and 5, the axle and guide wheel arrangement 50 is formed in two parts which are removably attached via a screw joint—a head portion 52 which extends out from the side of the door panel, and a tail portion 54 which is journalled onto the side stile of the door panel.

The head portion comprises the guide wheel 55 and a spacer portion 56 having a polygonal (preferably hexagonal) portion to allow engagement by a standard sized spanner.

The elongate tail portion 54 is generally cylindrical, to be received in a bearing attached to the panel side stile. Whilst in FIG. 5—showing the top door panel which is in use adjacent the curve in the guide track—this bearing is on a bracket attached to the stile, on the lower door panels the bearing will typically be within the stile so that the tail portion of the axle extends through the side stile.

The tail portion includes a formation to allow cooperation with a tool for restraining rotation of tail while the hex portion of the head portion is unscrewed to separate the two parts of the axle assembly. The formation on the tail may include another hexagonal portion, but preferably, in view of the limited space within the top lip of the door panel, comprises an aperture 58 in or through the tail portion for receiving a screwdriver, a spike or the like.

In use, this arrangement allows replacement or repair of the guide wheels, and/or contributes to increased ease of replacing an individual panel or panels of the door without the need to remove the whole door curtain. This is useful for replacing a panel which is damaged for example by contact with a motor vehicle, as occurs surprisingly often.

To replace an individual panel or panels, the panels above the one(s) to be removed may be suspended in position by attaching a sling to the head portions of the respective axles of the panel immediately above, with the other ends of the slings being attached to the upper part of the track or the building structure. The panel to be removed is then disconnected from the panel immediately above, and the panel to be removed and any panels below it then lowered to the bottom of the track.

Any panel below the one to be removed is also disconnected from the one to be removed, and the axles of the panel to be removed are unscrewed as described above to allow the panel to be lifted clear of the track.

The replacement or repaired panel may be reinserted into the door curtain in essentially the opposite set of steps.

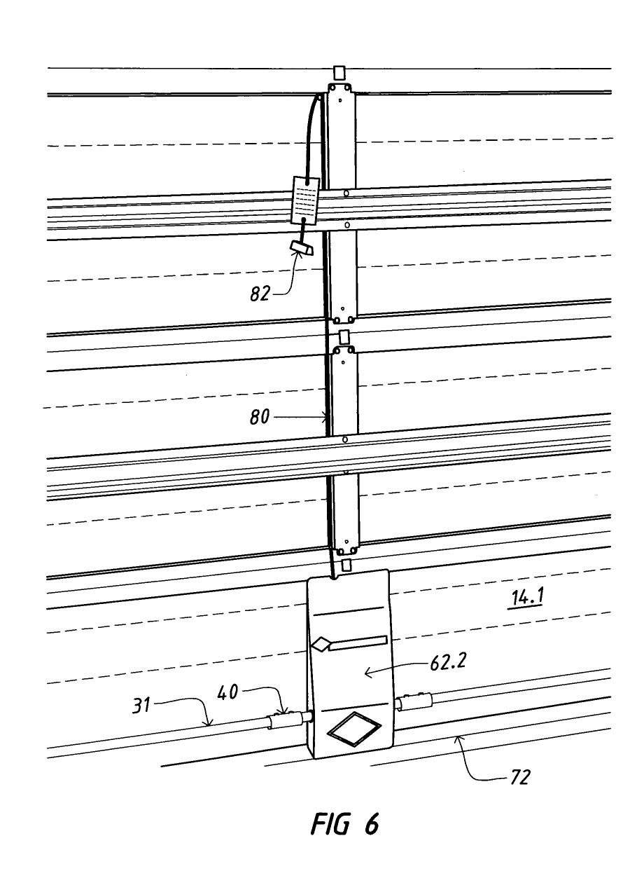

FIG. 6 shows a motor disengagement cord arrangement according to a further form of the invention.

In FIG. 6, the drive motor (not visible) is enclosed within the centre stile 62.2 of the lower panel 14.1. The disengagement cord 80 connects and operates engagement and disengagement of the motor in the usual way, by pulling of the cord, as understood in the art

The cord 80 passes up from the lower panel to a higher panel—preferably approximately two or three panels above—and has a loose end culminating in a handle 82.

By this arrangement, the handle is at a reachable height for operation regardless of whether the door is raised or lowered. When the door is lowered, as shown in FIG. 6, the end portion of the cord hangs down to a comfortable height approximately lm from the bottom of the door. The handle can be grasped and pulled at an angle from the door panel, to pull the actuator mechanism and engage/disengage the motor.

When the door is raised, the end portion of the cord hangs down so that the handle may still be reached by an adult of typical height range and pulled down (i.e. 90 degrees to the door, which will be overhead) to actuate.

FIG. 7 is a perspective from below of the bottom panel, showing a reinforcing arrangement adapted to counter excessive sag of the bottom panel under the weight of the motor and torsion spring assemblies.

In conventional sectional panel doors of over a certain width, additional reinforcement of the panels is employed in the form of double side stiles, and ‘top-hat’ section reinforcing members such as that shown at reference 70 in FIG. 2. However, the use of a top-hat section in the embodiments of present invention limits headroom of the door when opened.

The configuration of FIG. 7 includes an alternative reinforcing arrangement, in the form of a reinforcing member 72 secured by screws or other suitable means to the rear of the bottom lip of the panel and to the bottom of the centre and side stiles of the door.

In the illustrated embodiment the reinforcing member is an angle section, for example 25 by 50 mm aluminium angle at 3 or 4.5 mm thickness as required for sufficient rigidity. However, other suitable sections or materials may be used for the reinforcing member, for example channel or closed (e.g. box) section extrusions of steel or aluminium.

The illustrated arrangement provides a compact arrangement for an increasing rigidity of the panel, without encroaching on the headroom as in the prior art.

In this specification, the word “comprising” is to be understood in its “open” sense, that is, in the sense of “including”, and thus not limited to its “closed” sense, that is the sense of “consisting only of”. A corresponding meaning is to be attributed to the corresponding words “comprise, comprised and comprises where they appear.

While particular embodiments of this invention have been described, it will be evident to those skilled in the art that the present invention may be embodied in other specific forms without departing from the essential characteristics thereof. The present embodiments and examples are therefore to be considered in all respects as illustrative and not restrictive, the scope of the invention being indicated by the appended claims rather than the foregoing description, and all changes which come within the meaning and range of equivalency of the claims are therefore intended to be embraced therein. It will further be understood that any reference herein to known prior art does not, unless the contrary indication appears, constitute an admission that such prior art is commonly known by those skilled in the art to which the invention relates.

1. An overhead sectional door apparatus operative to open and close a door opening, the apparatus comprising:
a door curtain having a plurality of connected panels each having opposite side extremities;
guide track means for guiding movement of the door curtain between a closed, lowered position and an open, overhead position; and
a counterbalancing mechanism for applying a counterbalancing force acting against the weight of the door curtain, including:
a torsion spring mechanism mounted to the door curtain so as to be raised or lowered with operation of the door; and
a loading mechanism for loading the spring as the curtain is lowered, so as to create a counterbalancing force acting against the weight of the door curtain,
wherein the loading mechanism includes a torsion shaft portion and associated winding mechanism which are positioned outwards beyond at least one of the side extremities of a panel to which the spring mechanism is mounted.

2. An overhead sectional door apparatus as claimed in claim 1, wherein:
said winding mechanism comprises a cable reel.

3. An overhead sectional door apparatus as claimed in claim 1, wherein:
said guide track is spaced outwardly from the side extremities of the panels; and
said torsion shaft portion and said winding mechanism are located between the track and the panel side extremity.

4. An overhead sectional door apparatus as claimed in claim 1, wherein:
said door panel includes a side reinforcing member; and
the torsion shaft extends through the side reinforcing member.

5. An overhead sectional door apparatus as claimed in claim 1, wherein:
said door apparatus further comprises a drive motor for raising and lowering the door curtain, the motor being mounted on the door panel and being connected to respective loading mechanisms extending to each of said side extremities of the door panel.

6. An overhead sectional door apparatus as claimed in claim 5, wherein:
said drive motor is substantially centrally mounted on the door panel.

7. An overhead sectional door apparatus as claimed in claim 5, wherein:
said respective loading mechanisms are demountably coupled to said drive motor in situ.

8. An overhead sectional door apparatus as claimed in claim 7, further including:
longitudinally retractable covers on said respective loading mechanisms.

9. An overhead sectional door apparatus as claimed in claim 5, wherein:
said drive motor is mounted on a lower panel of the door curtain; and
the apparatus further including a drive motor disengagement mechanism comprising a disengagement chord attached at one end thereof to said drive motor and having at another end thereof a handle portion, wherein an intermediate portion of the disengagement cord is supported from a higher panel of the door curtain so that the handle portion hangs down from said higher panel whether the door curtain is in said closed or open positions.

10. An overhead sectional door apparatus as claimed in claim 1, further comprising:
guide members on said door panels for co-operating with the guide track, wherein the guide members are adapted for disengagement of the curtain from the track so that individual panels of the door may be replaced without disengaging other panels from the guide tracks.

11. An overhead sectional door apparatus as claimed in claim 10, wherein:
said guide members each comprise an axle and guide wheel arrangement, said axle and guide wheel being separable in situ for said disengagement of the respective panel from the guide track.

12. A guide track and axle arrangement for an overhead sectional door apparatus including a door curtain having a plurality of connected panels each having opposite side extremities, the guide track and axle arrangement comprising:
guide track means for guiding movement of the door curtain between a closed, lowered position and an open, overhead position; and
guide members associated with the panels for guiding movement of the panels relative to the guide track;
wherein the guide members are adapted for disengagement of the curtain from the track so that individual panels of the door may be replaced without disengaging other panels from the guide tracks.

13. A guide track and axle arrangement as claimed in claim 12, wherein:
said guide members each comprise an axle and guide wheel arrangement, said axle and guide wheel being separable in situ for said disengagement of the respective panel from the guide track.

14. A guide track and axle arrangement as claimed in claim 13, wherein:
said axle is formed in a first portion attached to the door panel and a second portion carrying a guide wheel, the two portions being separable while in situ.

15. A guide track and axle arrangement as claimed in claim 14, wherein:
said two portions of said axle are removably screwed together, and have formations for engagement of tools for unscrewing said portions while in situ.
